(19) United States
(12) Patent Application Publication
(10) Pub. No.: US 2019/0180382 A1
(43) Pub. Date: Jun. 13, 2019

(54) METHODS AND SYSTEMS FOR DRIVER AND/OR ITINERARY IDENTIFICATION

(71) Applicant: INNOVATION OF THINGS LTD, Newcastle Upon Tyne Northumberland (GB)

(72) Inventors: Stephen COWPER, Bury St Edmunds Suffolk (GB); Philip KENDALL, Mirfield Yorkshire (GB)

(21) Appl. No.: 16/301,022

(22) PCT Filed: May 12, 2017
(86) PCT No.: PCT/GB2017/051320

§ 371 Date: Nov. 13, 2018

(30) Foreign Application Priority Data
May 16, 2016 (GB) 1608608.4

(51) Int. Cl. G06Q 40/08; G06Q 50/30; B60W 40/08; G07C 5/00; G07C 5/08

(52) U.S. Cl. CPC G06Q 40/08; G06Q 50/30; B60W 2040/0809; G07C 5/008; G07C 5/085; B60W 40/08

(57) ABSTRACT

A method of associating one or more drivers to a vehicle is disclosed which comprises: providing a reference itinerary between a first location O and a second location A, and N reference locations L1, L2, . . . , LN situated on said reference itinerary; for each of different journeys performed by any one of the drivers by driving the vehicle on the reference itinerary, capturing at least one signal representative of the driving of said driver in conjunction with the N reference locations L1, L2, . . . , LN; and, comparatively evaluating the captured signals. By setting the reference locations, in space, along the reference itinerary on which the one or more drivers may drive the vehicle, it is possible reliably to identify whether one or indeed more than one drivers usually drive the vehicle. This information can be used, advantageously, in the context of Usage Based Insurance.

### CROSS-REFERENCE TO RELATED APPLICATIONS

The present application claims priority to PCT International Patent Application No. PCT/GB2017/051320, filed May 12, 2017 and Great Britain Patent Application No. 1608608.4, filed on May 16, 2016, the disclosure of which are incorporated herein by reference.

### STATEMENT RE: FEDERALLY SPONSORED RESEARCH/DEVELOPMENT

Not Applicable

### FIELD OF THE INVENTION

The present invention relates generally to methods and systems for identifying drivers and/or itineraries associated with a vehicle, or for validating said drivers and/or itineraries in connection with the usage of said vehicle. In particular, the present invention relates to a method of associating one or more drivers to a vehicle; a method of validating a journey driven by a driver of a vehicle on a reference itinerary associated with the vehicle; a method of identifying whether a vehicle driven by a driver associated with the vehicle on a journey is driven on a reference itinerary; and, a method of determining one or more reference itineraries associated with a vehicle; and, to related telematics systems.

### BACKGROUND

Usage Based Insurance (UBI) policies are based on vehicles. This means that a number of named drivers are usually added on the policy in connection with a specified vehicle. Oftentimes, a single driver is named. Insurers wish to know whether the vehicle is driven by the named driver or drivers, or whether the policies may be the subject of fraud by the insured vehicle being driven by drivers not permitted under the policies.

Some insurers use smartphone based solutions, whereby data related to or collected by a smartphone are sent to the insurers and used for assessing risks related to the insured vehicle. These data can also be used to assess whether the insured vehicle has been driven by any unpermitted drivers. It is difficult, however, to discern whether the data communicated by the smartphone are genuine. A passenger could in fact fraudulently misrepresent himself as the driver of the vehicle, for example during low risk, well driven journeys aboard the vehicle. This could illegally reduce the risk rating of this “assumed” driver, and therefore the insurance premium, associated with the fraudulent smartphone user.

Current UBI techniques are limited. The insurer has generally to treat the vehicle as the insured entity and is not able to distinguish between different drivers even in situations where this is allowed, such as when the vehicle is insured to a driver and his spouse.

Methods involving the driver self-reporting driving information via a smartphone (or website) are unreliable and open to illegal use, as described above.

Key-fobs operating Near Field Communication (NFC) technology are known which interact with a telematics box permanently installed in the vehicle so that the driver can “check in” and “check out” from the vehicle thereby clocking the relevant mileage and/or other information on the key-fobs. This information is then transmitted to the insurer for analysis. These methods are particularly used in fleet management, but are generally not appropriate for the general public (e.g. in connection with domestic vehicle insurance policies) as it would be unreasonable to expect users to be able accurately to capture their vehicle usage on the key-fobs during normal daily life.

The present invention addresses one or more of the aforementioned limitations by using sometimes subtle differences in the way drivers tend to drive the vehicle, i.e. brake, accelerate etc. . . . .

### BRIEF SUMMARY OF SOME EMBODIMENTS OF THE INVENTION

According to an aspect of the present invention, there is provided a method of associating one or more drivers to a vehicle, the method comprising:

providing a reference itinerary between a first destination O and a second destination A (this being optionally distinct from the first destination O), and N reference locations L1, L2, . . . , LN situated on said reference itinerary;

for each of different journeys performed by any one of the drivers by driving the vehicle on the reference itinerary,

capturing at least one signal capable of representing the driving of said driver in connection with each of said N reference locations L1, L2, . . . , LN;

comparatively evaluating the captured signals.

This method applies to a reference itinerary, and to N specific reference locations L1, L2, . . . , LN situated on said reference itinerary. This method uses data capture or acquisition across a plurality of journeys driven by initially unknown drivers on the reference itinerary. The captured data are capable of being associated to the driving styles of the drivers on these journeys carried out on the reference itinerary. By comparatively evaluating the captured data is therefore possible to compare the driving styles of potentially different drivers, and therefore it is potentially possible reliably to identify whether one or more drivers drive the vehicle, and/or how often. This information can be useful to the insurers of the vehicle in the context of UBI. We refer to this aspect as the first ‘Driver Identification’ mode.

The method may further comprise processing the captured signals to obtain N post-processing results associated with the N reference locations along the reference itinerary for each journey. The method may accordingly further comprise comparatively evaluating the N post-processing results across the different journeys. Different “metrics” may be chosen, among those available in the art, to compute the N post-processing results. With the term “metrics” we intend different post-processing algorithms which may be applied to the raw captured data. “Metrics”, therefore, not only involve the determination of one or more post-processing functions to be applied to the raw data, but also indication of the raw data to which the post processing functions are applied and how.

In a preferred embodiment, for its simplicity of implementation, the post-processing results may be calculated as the average speed of the vehicle between the reference locations L1, L2, . . . , LN. Further possible metrics are described in the specific description hereinbelow.

In some embodiments, the captured signals may be pre-processed, i.e. preliminarily prepared, in preparation for the post-processing. Pre-processing may preferably take place on the same device used for data capture.

The method may further comprise transmitting the captured signals, pre-processing results and/or the post-processing results to a remote server or memory. Accordingly, the pre-processing of the captured signals and/or the post-processing results may be carried out remotely. Transmitting the captured signals, pre-processed signals and/or post-processing results to the remote server or memory is optionally carried out by a telematics system associated with the vehicle, optionally automatically, i.e. without input requested from the driver and/or passenger of the vehicle.

The comparative evaluation of the post-processing results may comprise visualizing the post-processing results against the N reference locations for the different journeys. Optionally, it is possible to plot the post-processing results to reveal any one or more scatter patterns, or clusters, in the post-processing results.

The method may accordingly comprise comparing said clustered post-processing results. The method may further be implemented over a plurality of the journeys. The plurality of the journeys may optionally be statistically representative of the driving of the one or more drivers. A number of statistical techniques, may be devised to improve the analysis of the post-processing results and therefore the reliability of the methodology, as will be recognized by the skilled person. These methodologies, however, do not form part of the present disclosure. Likewise, supervised or unsupervised machine pattern recognition techniques may be employed to arrive at the identification of the one or more drivers. These methodologies too, however, while cited, do not form part of the present disclosure.

Any of said reference locations L1, L2, . . . , LN may be selected or calculated (for example automatically by the telematics system associated with the vehicle) such that they correspond to any one or more of the following road descriptions: “straight road”; “bendy road”; “sharp corner”; “slope”; “bridge”; “roundabout”; “highway”; “state road”; “local road”. Said selections or calculations are optionally carried out by or in conjunction with the telematics system associated with the vehicle.

Advantageously, the first destination O may represent a Home Location associated with the vehicle. The acquisition of data may therefore be enhanced by the ready availability of journeys carried out to or from the Home Location. The second destination A may advantageously represent a landmark location associated with the Home Location of the vehicle, e.g. a commuting location, such as an office location, a hospital, a petrol station, a supermarket, a school etc. The landmark location may optionally be selected, or automatically computed by the telematics system, so as to be within a few kilometers from the Home Location. In preferred embodiments, the second destination A is within 5, 4, 3, 2, 1 or 0.5 Km from the first destination O.

The method may further comprise setting the Home Location. Setting the Home Location may comprise determining a frequency of vehicle ignition and/or vehicle stop events associated with the vehicle at the Home Location. Setting the home location and/or determining said frequency of vehicle ignition and/or vehicle stop events is optionally carried out by a telematics system associated with the vehicle, optionally automatically, i.e. without the need for user input or further user input.

In preferred embodiments, the method may comprise providing more than one reference itineraries, for example M reference itineraries R1, R2, . . . , RM, and corresponding reference locations, for example L11, L12, . . . , L1N; L21, L22, . . . , L2N; . . . ; LM1, . . . , LMN situated respectively on the M itineraries associated with the vehicle. Each reference itinerary may be between a first destination O and a respective second destination A, B, C, etc. (optionally distinct from the first destination O). For each of different journeys performed by any one of the one or more drivers by driving the vehicle on any one of the M reference itineraries, therefore, it may be possible to capture or acquire at least one signal representative of the driving of said driver in connection with the travelled reference locations. Optionally, at least two of said reference itineraries share at least one of said reference locations, for example when part of two distinct journeys to two different destinations, e.g. the supermarket and the school, is along a road in common between the two different itineraries. Each reference itinerary may have a fixed number N of reference locations, or the number of reference locations along the different itineraries may vary. The M reference itineraries are optionally provided by or to, a telematics system associated with the vehicle.

Capturing at least one signal representative of the driving of said driver in connection with the reference locations and/or comparatively evaluating the captured signals may be performed when the driver drives the vehicle only out of the first destination A, or only into said first destination O. This is on account of the fact that the driving behaviour of the driver may be different when driving in one direction or the other between two destinations O and A or O and B etc. For example, speed may be different when the vehicle is driven on a bend on one direction or in the other.

Providing said reference locations on the one or more reference itineraries between the first destination O and the second destination A, (optionally distinct from the first destination O); and/or providing said one or more reference itineraries O to A, O to B etc. and/or capturing at least one signal representative of the driving of said driver in connection with the reference locations may be carried out by a telematics system associated with the vehicle.

The telematics system may optionally comprise a GPS receiver programmed to receive a GPS signal representing a position and/or speed of the vehicle. The GPS signal may optionally receive at a rate of at least 1 Hertz. The GPS receiver is optionally provided within a GPS enabled device such as within a GPS navigator and/or within a GPS enabled smartphone or GPS enabled portable computer.

The telematics system may optionally comprise one or more sensors for sensing the at least one signal representative of the driving of said driver. The telematics system may optionally comprise a smartphone or portable computer programmed to capture said at least one signal representative of the driving of said driver. The telematics system can optionally be a GPS enabled smartphone or portable computer comprising one or more sensors for sensing the at least one signal representative of the driver's driving. Said one or more sensors may comprise any one or more of an accelerometer, a gyroscope and a magnetometer.

Capturing at least one signal representative of the driving of said driver may be carried out uninterruptedly along the journeys, or it may be triggered at correct times by corresponding triggers issued by the telematics system in correspondence to, or before the vehicle has reached, the reference locations. In preferred embodiments, said triggers are issued by the GPS enabled device. The captured signals may be sampled in the time and/or space domains. However, it is preferred that the captured signals be sampled in the space domain. Data captured in the time domain can be converted to be represented in the space domain, for example by knowing the relationship between space and time (speed) travelled by the vehicle. This may be readily available from the GPS system.

The captured signals may take the form of instantaneous data captures at the time instant when the vehicle is driven at any one or more of the reference locations. Alternatively, the captured signals may take the form of discrete data sequence captures performed before, while or after the vehicle is driven at any one or more of the reference locations. According to the latter case, the captured signals may have been captured within predetermined, finite time intervals or distances travelled by the vehicle in connection with any of the reference locations. Said predetermined time intervals or distances are optionally fixed, or are optionally dependent on the reference locations and/or itineraries. Said time intervals and/or distances are optionally determined by the telematics system, or are provided to the telematics system. In a very preferred embodiment, for its simplicity of implementation, the reference locations are equally spaced from one another and the signals are captured, in the space domain, for the entire duration of the journeys. Optionally, the signals are sampled at rates in excess of 1, 4, 5, 10, 20, 50 or 100 Hertz. Optionally, the reference locations are spaced about 100 meters from one another. Optionally, the reference itineraries are less than about 8, 7, 6, 5, 4, 3 2, 1.5, 1 or 0.5 km.

The at least one signal representative of the driving of said driver in connection with said reference locations may be one or more of: a vehicle acceleration; a vehicle speed; a vehicle angular velocity; a vehicle position; and/or a parameter directly or indirectly derived therefrom. Each of said vehicle acceleration, vehicle speed, vehicle angular velocity, vehicle position and parameter directly or indirectly derived therefrom may optionally be referred to any one or more axial components of a vehicle-based, or other, coordinates system.

According to a further aspect of the invention, there is provided a method of associating one or more drivers to a vehicle, the method comprising:

for each of different journeys performed by any one of the drivers by driving the vehicle from a first destination O to one or more second destinations on respective one or more reference itineraries,

capturing at least one signal capable of representing the driving of said driver in connection with a set of predetermined distances driven from the first destination O on the one or more reference itineraries;

comparatively evaluating the captured signals.

This method is similar to the first Driver Identification mode but applies to initially unknown reference itineraries. It involves measuring the driving of the unknown drivers at reference locations situated on the unknown itineraries at fixed distances from the first destination O (or Home Location, in preferred embodiments). Again, the method uses data capture or acquisition across a plurality of journeys driven by the initially unknown drivers. The captured data are capable of being associated to the driving styles of the drivers on these journeys, although these can now take place on different reference itineraries, which however share the first destination O. It is appreciated that, normally, only a limited number of reference itineraries are possible from the first destination O, especially when the first destination O represents the Home Location for the vehicle, and the set of predetermined distances in connection with which the driving is measured do not extend beyond for example 0.5, 1, 2, 3, 4 or 5 Kilometers from the first destination O. By comparatively evaluating the captured data, it is therefore still possible to compare the driving styles of potentially different drivers, and accordingly it may be possible reliably to identify whether one or more drivers drive the vehicle, and/or how often. This information too can be useful to the insurers in the context of UBI. We refer to this aspect as the second ‘Driver Identification’ mode. In very preferred embodiments, at least two journeys are driven by each driver on any one of the reference itineraries. In very preferred embodiments, a statistically relevant number of journeys is driven by each driver on any one of the reference itineraries. It will be appreciated that post-processing of the captured signals and “clustering” of the post-processed signals around the set of predetermined distances as described herein, may still be advantageous.

According to a further aspect of the invention, there is provided a method of validating a journey driven by a driver of a vehicle on a reference itinerary associated with the vehicle, said reference itinerary being between a first destination O and a second destination A (optionally distinct from the first destination O), the driver being one among a plurality of drivers associated with the vehicle, the method comprising:

providing a set of meta-data identifying the driver driving the journey;

providing reference data for each driver representative of the driving of said driver in connection with N reference locations L1, L2, . . . , LN situated along the reference itinerary;

capturing at least one signal representative of the driving of the driver on said journey in connection with each of said reference locations along the reference itinerary;

comparatively evaluating the captured at least one signal against the reference data, thereby,

validating whether the journey has been driven by the driver identified by the provided meta-data.

This method would enable, for example, an insurer to check whether a journey has been performed by an expected or declared driver. We refer to this aspect as ‘Driver Validation’.

According to a further aspect of the invention, there is provided a method of identifying whether a vehicle driven by a driver associated with the vehicle on a journey is driven on a reference itinerary, the method comprising:

capturing at least one signal representative of the driving of said driver in connection with a set of N reference locations L1, L2, . . . , LN along the journey, each of said reference locations being at a predetermined distance from a start destination O;

comparing the captured at least one signal with reference data associated with the reference itinerary and the reference locations.

This method would enable, for example, an insurer to route-match a journey driven by a driver to a reference itinerary without the need to rely on GPS data. We refer to this aspect as ‘Journey Matching’.

According to a further aspect of the invention, there is provided a method of determining one or more reference itineraries associated with a vehicle, the method comprising:

for each of different journeys driven by one or more drivers associated with the vehicle, capturing at least one signal representative of the driving of the driver in connection with each of N reference locations L1, L2, . . . , LN along the journey, each of said reference locations being at a predetermined distance from a start destination O;

clustering the captured signals around said reference locations;

comparing the clustered signals.

This method would enable, for example, an insurer to match journeys driven by potentially different drivers to one or more reference itineraries without the need to rely on GPS data. We refer to this aspect as ‘Itinerary Matching’. This method enables in addition reliably to set up one or more reference itineraries associated with a vehicle without relying on GPS data. This method can be used in connection with the first Driver Identification aspect of the invention, for example as a preliminary stage.

According to a further aspect of the invention, there is provided a telematics system adapted to carry out a method as described herein.

In a preferred embodiment, there is provided a telematics system comprising:

a GPS receiver for receiving a GPS signal representative of the position or speed of a vehicle;

a sensing device comprising one or more sensors for acquiring the at least one signal representative of the driving of a driver in connection with any of a set of reference locations situated on a reference itinerary; and,

a communication device capable of communicating the acquired signals to a remote repository;

wherein the GPS receiver, sensing device and communication device are each or all integrated into a smartphone or portable computer.

According to a further aspect of the invention, there is provided programming code, published, stored or installed onto a physical medium, said programming code containing instructions for setting up a telematics system as described herein. Physical media containing such programming instructions constitute further aspects of the invention.

While the invention will be described below in connection with several embodiments, it will be understood that the invention is not limited to these embodiments. On the contrary, the invention includes all alternatives, modifications, and equivalents as may be included within the scope of the appended claims.

Various additional features and advantages of the invention will become apparent to those of ordinary skill in the art upon reviewing the following detailed description of illustrative embodiments of the invention, in conjunction with the accompanying drawings.

### BRIEF DESCRIPTION OF THE DRAWINGS

The accompanying drawings, which are incorporated in and constitute part of this specification, show embodiments of the invention for illustrative purposes only, that is to teach the invention to the skilled person so as to allow the skilled person to carry out the invention within the scope of the appended claims.

FIG. 1 is a schematic representation of a GPS device in accordance with an embodiment of the invention.

FIG. 2 is a flow chart representing methods in accordance with embodiments of the invention.

FIG. 3 illustrates, schematically, three reference itineraries associated with a vehicle, which may be determined in accordance with an embodiment of the invention (Itinerary Identification).

FIG. 4 shows speed vs distance records in connection with a vehicle driven by two different drivers on a specified itinerary, the records having been made using a device according to FIG. 1.

FIG. 5 shows longitudinal acceleration vs distance records in connection with a vehicle driven by two different drivers on a specified itinerary, different with respect to that referred to in FIG. 4, the records having been made using the device of FIG. 1.

FIG. 6 shows lateral acceleration vs distance records in connection with a vehicle driven by two different drivers on a specified itinerary, corresponding to those shown in FIG. 5.

FIG. 7 shows two different metrics relating to a single driver driving seven journeys through nine reference locations situated on a reference itinerary, calculated according to a method in accordance with an embodiment of the present invention.

FIG. 8 shows two different metrics relating to two drivers driving several journeys through nine reference locations situated on a reference itinerary, calculated according to a method in accordance with an embodiment of the present invention.

### DETAILED DESCRIPTION

The detailed description set forth below is intended as a description of the presently preferred embodiment of the invention, and is not intended to represent the only form in which the present invention may be implemented or performed. The description sets forth the functions and sequences of steps for practicing the invention. It is to be understood, however, that the same or equivalent functions and sequences may be accomplished by different embodiments and that they are also intended to be encompassed within the scope of the invention.

Differences in the driving style adopted by drivers can successfully be utilized to identify how many drivers have access to and usually drive a given vehicle. To achieve this, parameters capable of characterizing the driving of the vehicle are measured and are referred to fixed locations in space along one or more possible reference itineraries for the vehicle. We call this functionality Driver Identification. Two Driver Identification modes are possible. The first one relies on the provision of reference itineraries and sets of reference locations situated on said reference itineraries. The second is based on reference locations at fixed space distances from a first reference destination O. The first reference location is Xm kilometers from the first destination O, and the second and further reference locations are distant twice Xm, three times Xm etc., i.e. multiples of Xm, from the first destination O. It will be appreciated that both Driver Identification modes are based on the same principles, i.e. that it is possible to characterize the driving of different drives by comparing their driving in connection with reference locations univocally identified in space.

Similarly, if a given driver drives a vehicle on different itineraries, the driving of that specific driver at or in proximity of a set of fixed distances travelled each time by the vehicle from a reference destination depends on the itinerary, not on the driver. This gives rise to an opportunity to identify different itineraries on which the driver has driven the vehicle without recurring to a GPS system. We call this functionality Itinerary Identification. Itinerary Identification may be preparatory to Driver Identification, i.e. possible reference itineraries are first determined and then used as the basis of Driver Identification by selecting a set of reference locations thereupon.

If the driver is known, it is possible to compare his or her driving on a given itinerary with a model relating to that driver and itinerary. It is accordingly possible to validate journeys by determining whether the expected, or declared, driver has actually driven the vehicle on a journey on the reference itinerary. We call this functionality Driver Validation.

It is finally also possible, using the same principles, to attribute a journey driven by one or more drivers to one of many possible reference itineraries without recurring to a GPS system. We call this functionality Journey Matching.

Drivers tend to replicate their driving behaviour at specific locations along any given itinerary, across different journeys. The appreciation of this principle is common to the above-listed functionalities. These driving behaviours can therefore usefully be measured, and recorded, and information can be derived therefrom to achieve the above functionalities.

Modern telematics systems associated with vehicles, and/or the widespread availability of intelligent equipment such as computers, smartphones, tablets and the like, increases the attractiveness of the above functionalities, as further described below.

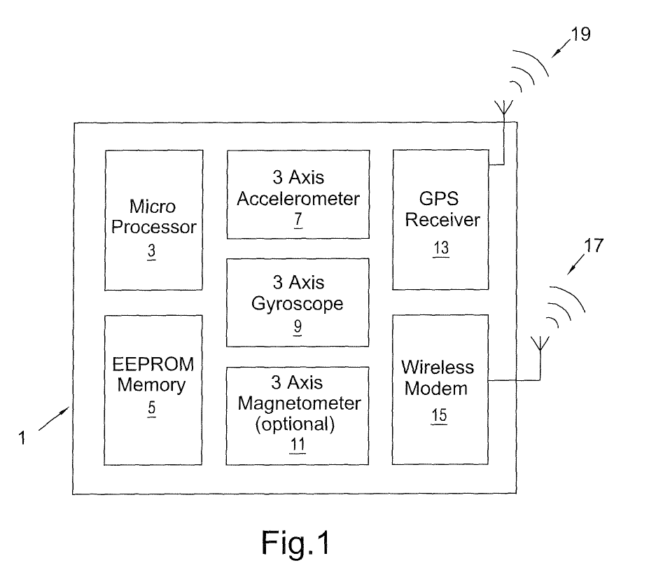

With reference to FIG. 1, there is schematically shown a mobile telematics system 1 according to an embodiment of the present invention, associated with a vehicle V1 (not shown in the drawings). The system 1 includes a microprocessor 3; an EEPROM memory 5; a three-axis accelerometer 7; a three-axis gyroscope 9; a three-axis magnetometer 11; a GPS receiver 13, and a wireless modem 15. The system 1 receives a GPS signal 19 via the GPS receiver 13 and is also capable of receiving and sending data 17 over an internet connection, as known in the arts. The GPS 19 signal may alternatively be carried over the internet connection.

The GPS signal 19, in this embodiment, represents the coordinates (position) of the vehicle, and its speed. The accelerometer 7 measures the acceleration of the vehicle V1 in the longitudinal and lateral directions with respect to the vehicle's sense of travelling. In embodiments of the invention, vertical acceleration may in addition be used. The gyroscope 9 and magnetometer 11 may additionally measure further parameters related to the travelling of the vehicle so as to improve and extend the scope of the captured data, but are not used in the embodiment described herein.

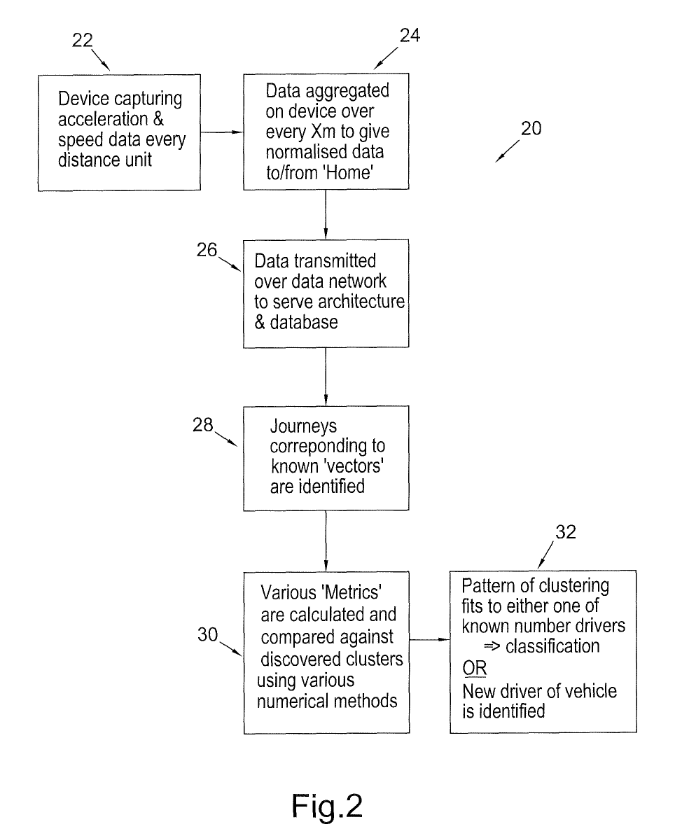

As the vehicle V1 travels, the speed and position of the vehicle V1 detected by the GPS receiver 13 and the longitudinal and lateral acceleration of the vehicle V1 detected by the accelerometer 7 are recorded into the EEPROM memory 5. The recorded data can either be processed locally, by microprocessor 3, or remotely by sending the records to a remote repository, which can be a database or server (not shown), or other device, over the internet connection via the wireless modem 15. Where the processing of the GPS and acceleration data is carried out is not crucial for the implementation of the present methods. It is instead important to discuss how the data are captured, what they represent, and how they are processed and this is discussed in more detail with reference to FIG. 2.

With reference to FIG. 2 there is shown a flow diagram illustrating a data capture and processing strategy 20 according to an embodiment of the present invention.

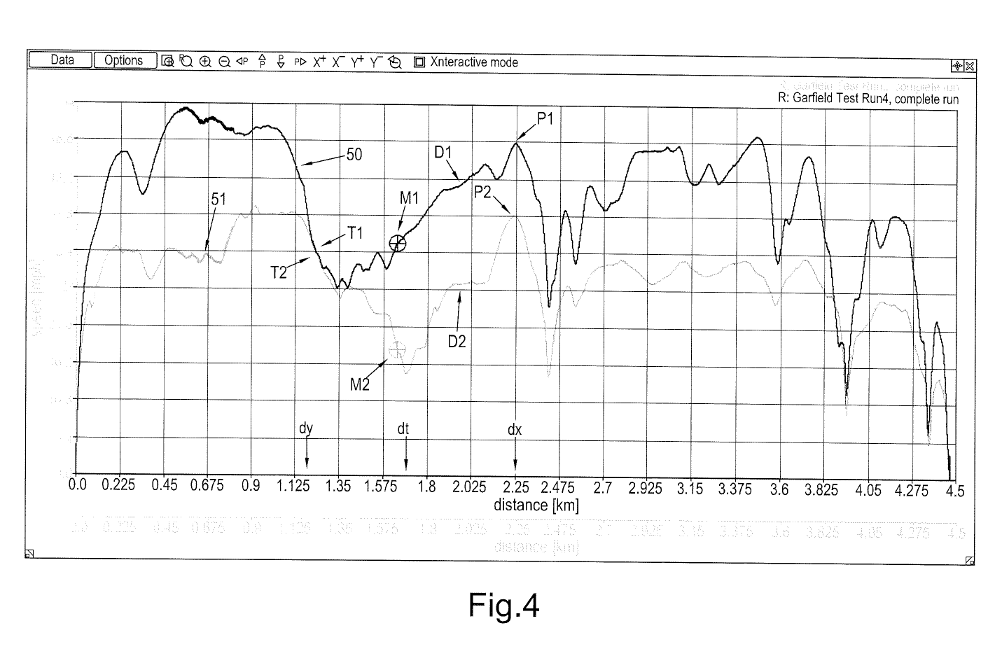

In this embodiment, data descriptive of the driving of the driver are captured 22 every about four meters from a first, reference destination associated with the vehicle V1 that represents, in this embodiment, a Home Location O for the vehicle V1. In this embodiment, the speed of the vehicle and its lateral and longitudinal accelerations are acquired. Note that it would alternatively be possible to acquire the data of interest in the time domain. It is possible to translate the acquired data into the space domain using the GPS signal, if required. The use of the time and/or space domain is equally possible insofar as data are captured which may be representative of the driving of the driver in connection with fixed locations in space, which are given by the reference locations described above. Comparing different driving styles is the underlying aim of the methods described herein, and considering fixed (therefore comparable) locations in space enables this. FIGS. 4, 5 and 6 show examples of traces captured at this stage 22 of the procedure, and are further described below.

The captured data are pre-processed 24 by the microprocessor 3 locally in the GPS mobile device 1. This pre-processing is such that sequences or partitions of the captured data are allocated (i.e. aggregated) to a set of reference locations each distant Xm meters from each of the neighbouring reference locations, and one or more multiples of Xm from or to the Home Location O. This step is named, in the described embodiment, ‘data normalization’ in that the acquired data are thereby referred to a set of selected reference locations on the journey performed by the vehicle V1. It should be noted that at Xm=the distance between two samples of the same sampled signal (i.e. about four meters in the present embodiment), each aggregation (partition, or sequence) would merely comprise one data sample. At Xm=twice the distance between two samples of the sampled signal (i.e. about eight meters in the present embodiment), each aggregation would comprise two data samples, etc. At Xm=100 meters, each aggregation would comprise around 25 data samples. In this embodiment, this pre-processing step is carried out by directly associating to each reference location the entire sequence of data captured between the preceding reference location and the reference location in question. This is made possible by the data having been originally acquired in the space domain. However, the skilled person will recognize that other data aggregation strategies will be possible within the scope of the present invention in order for the captured data to represent the driving of the drivers or drivers on suitable segments, and in correspondence with suitable locations, along the driven itinerary. Likewise, different data-capture strategies are also possible.

The pre-processing results are then transmitted 26 over the internet connection to a remote server (not shown) so that they can be remotely post-processed as required. Before the post-processing can take place, however, at least in this embodiment, the journeys of the vehicle V1 for which data have been captured are associated to one or more reference itineraries and these reference itineraries are correspondingly selected 28 to form the basis for the post-processing. In other words, only journeys of the vehicle V1 corresponding to any one of a set of known itineraries are taken into consideration. This step can be carried out on the basis of the availability of the GPS signal, as is known in the arts. Alternatively, it is possible to carry out an Itinerary Identification procedure based on the available data, as described above. This does not require GPS data. For the present purposes, only journeys carried out on one or more reference itineraries are considered.

For selected journeys, carried out on one or more reference itineraries associated with the vehicle V1, various metrics are used to calculate 30 a set of post-processing results and to associate them to the reference locations. Each post-processing result will therefore be representative of the driving of the driver of the vehicle V1 in connection with said reference locations.

In the described embodiment, the post-processing is performed by calculating average vehicle speed, average longitudinal acceleration and average lateral acceleration every Xm meters, these averages being taken on the sequences of aggregated data as described above between a given reference location and the one immediately preceding. Therefore, at each reference location, will correspond an average speed, average lateral acceleration and average longitudinal acceleration of the vehicle V1 relative to the travel of the vehicle V1 from the earlier reference locations and the present one. These metrics are representative of the driving of the driver between the earlier reference location and the current reference location.

Different metrics can be used to post-process the acquired data and are described further in the next paragraph. However, if the same metrics are used in connection with different drivers driving different journeys on the same reference itinerary or itineraries, and if the post-processing results are graphically rendered versus the reference locations, this provides for visual interpretation of the captured data so as to identify 32 whether one or more drivers drive the vehicle. New drivers driving a known vehicle can likewise be identified.

Denoting x(t) the position of the vehicle in the x axis as a function of time, and y(t) the position of the vehicle in the y axis as a function of time, alternative metrics could be provided by the following functions:
Sum(x(t), y(t));
Sum(x²(t), y²(t));
Mean(Abs(x(t), y(t)));
Mean(x²(t)−x₀²(t) y²(t)−y₀²(t)); where x₀ and y₀ are reference values at a notional time to t) when the vehicle V1 transits by the earlier reference location.

Similar metrics can be elaborated, as known in the arts, starting from the first and second derivatives of the vehicle position x′(t) and y′(t), representing the respective speeds on the x and y axes, and x″(t) and y″, representing the respective accelerations.

In embodiments, as a possible metric it is possible to calculate the Frechet distance between x(t) and/or y(t) curves, as recorded for different drivers, in each segment associated with a reference location, and correlate this to the mean values of those functions in the same segments. The skilled person will appreciate that many additional metrics for the computation of the N post-processing results are likewise possible.

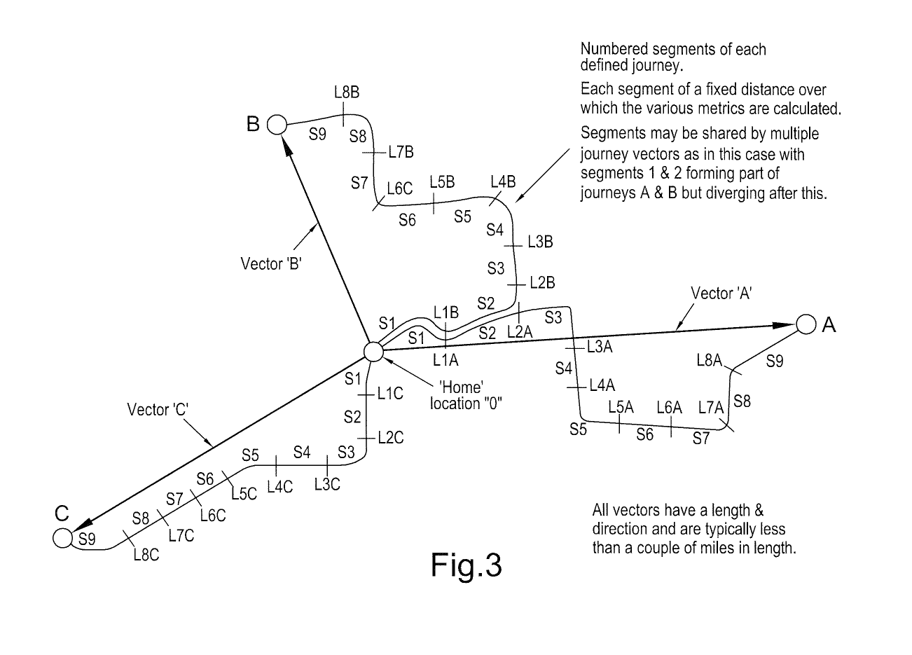

Further details of the methods described herein are provided below with reference to FIGS. 3-8.

With reference to FIG. 3, there are shown, schematically, three reference itineraries associated with the vehicle V1, these being itinerary A, between Home Location O and destination A; itinerary B, between Home Location O and destination B; and, itinerary C, between Home Location O and destination C. In FIG. 3, itineraries A, B and C are represented both vectorially, i.e. by means of arrows joining the Home Location O with the respective destinations A, B and C (which represent the distance and direction of each itinerary) and by corresponding curves A, B and C representing actual routes between the Home Location O and the respective destinations A, B and C.

As shown in FIG. 3, itineraries A and B share part of the respective routes between Home Location O and reference locations L2A and L2B. Each itinerary is divided into nine equal segments S1 to S9 by setting eight reference locations on each itinerary, namely L1A to L8A for reference itinerary A, L1B to L8B for reference itinerary B and L1C to L8C for reference itinerary C. Segments S1 to S9 on itinerary B are longer than segments S1 to S9 on itinerary C since itinerary B is longer than itinerary C.

The reference itineraries shown in FIG. 3 associated with vehicle V1 have been programmed into GPS mobile device 1 by means of a GPS software. Alternatively, these itineraries could be manually entered or automatically detected using Itinerary Identification as further described below.

A, B and C may represent three different landmarks, preferably a couple of miles or less away from the Home Location O, e.g. a hospital, a supermarket and a petrol station. Itineraries may depend on the direction of travel of the vehicle. Therefore, itinerary O-A is considered different from itinerary A-O, and likewise for itineraries O-B and O-C. In different, but possible, embodiments, the itineraries are not dependent on the direction of travel of the vehicle.

FIG. 4 shows recorded vehicle speed traces 50, 51 for two drivers, respectively identified by D1 and D2, driving the vehicle V1 on a given, 4.5 Kilometers long itinerary. The drivers D1 and D2 show remarkably different driving styles with driver D1 being generally faster than driver D2. Features of the speed traces 50 and 51 tend to be in common at specific distances along the itinerary, e.g. peaks P1 and P2 at distance dx=2.25 Km. This means that, at least to some extent, the driving style will be imposed by the itinerary. This itinerary, for example, imposes acceleration and then deceleration respectively just before and after distance dx. dx actually represents a valley in the reference itinerary, i.e. the lowest point after a descent and just before an ascent on a sloping, straight road.

At T1 and T2, the speed of the drivers D1 and D2 is substantially the same. This represents a requirement to meet a speed limit on the itinerary in connection with location dy. At least to the trained eye, it will readily be possible to distinguish drivers D1 and D2 by comparing the respective speed traces 50, 51 on the reference itinerary. However, as it will be described below, different comparisons are possible and often useful, involving one or more different metrics.

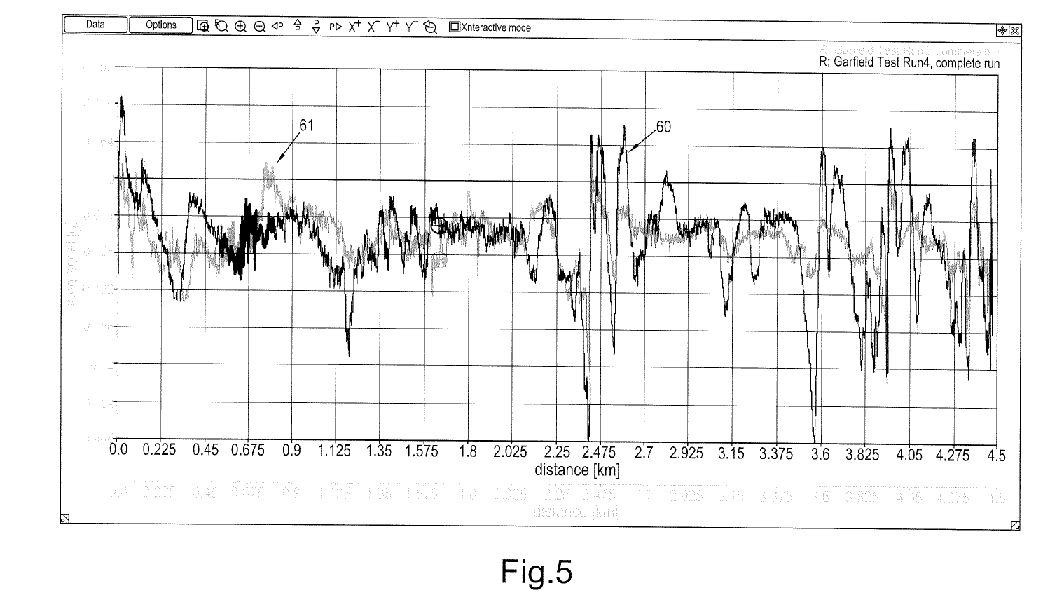

With reference to FIG. 5, there are shown traces 60, 61 of longitudinal acceleration versus distance for the same drivers D1, D2 of FIG. 4 but different journeys on a different itinerary. Positive values of the traces 60, 61 correspond to accelerations and negative values correspond to decelerations of the vehicle V1.

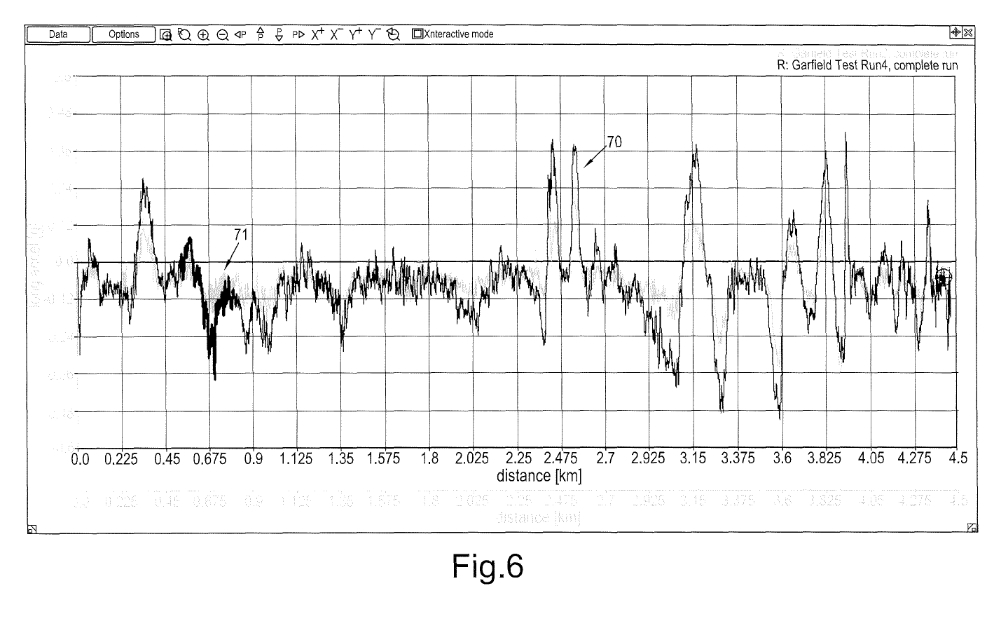

With reference to FIG. 6, there are shown traces 70, 71 of lateral acceleration versus distance for the same drivers D1, D2 for the same journeys and same reference itinerary as in FIG. 5. Positive values correspond to lateral acceleration and negative values correspond to lateral deceleration of the vehicle V1. Values of traces 70 and 71 are closer to zero on straight roads and they tend to be further away from zero on bendy and curvier roads.

Reference to longitudinal and lateral acceleration traces as in, respectively, FIG. 5 and FIG. 6 may be particularly helpful when speed traces such as those shown in FIG. 4 are inconclusive as to the identification of the one or more drivers, even when post-processed.

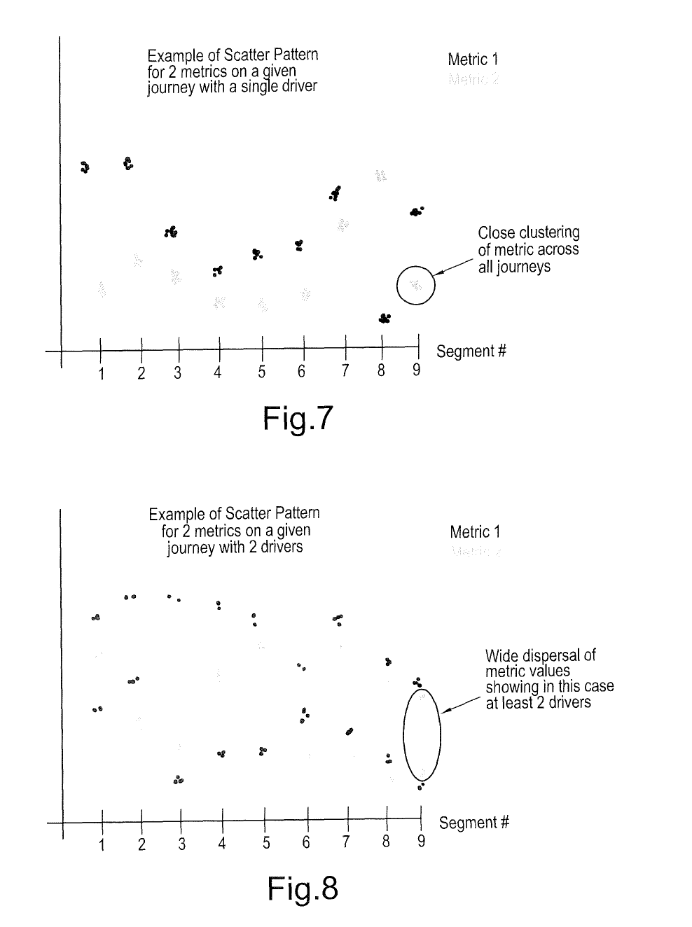

FIG. 7 is a schematic representation of the effect of plotting two selected metrics against segment number for one of the itineraries shown in FIG. 3 and the same driver D1, across seven journeys. As expected, the post-processing results tend to group in clusters for different journeys, with some scatter due to contingencies such as traffic levels which may reflect different hours of the day, impact of road furniture such as traffic lights, pedestrian crossings etc. The close level of clustering in FIG. 7 is due to the presence of a single driver.

FIG. 8 is a schematic representation of the effect of plotting the same metrics of FIG. 7 for two different drivers. Dispersal of the same metric revels the different drivers.

It is appreciated that for any given vehicle, such as the vehicle V1 described herein, there will usually be no more than a few regular drivers. Likewise, there will be only a few regular route vectors of, say, under about 8 Kilometers (even if these are partial routes at the start of longer journeys). These factors contribute to the likelihood of success of the methods described herein. There will be some variation in the acquired data due to time of day or traffic levels, but this can be averaged or filtered out by acquiring data over a plurality of the journeys, or a large plurality.

Similarly, once a number of discrete drivers has been identified, new journeys either starting or terminating at the Home Location along one of the prescribed reference itineraries can be associated to one of the drivers.

The invention arises from the appreciation that a large number of driving behaviours, for example breaking behaviour, speed around corners and over rises, acceleration from standstill, general speed (this being most susceptible to traffic) are characteristics of the drivers, but in order to be able to compare these characteristics it is necessary to refer them to appropriate and specific driven segments, that is, in other words, these characteristics have to be assessed in connection with specific locations in space. These behaviours are associated to road features on the itineraries travelled by the vehicle. It can therefore readily be appreciated that by using external meta-data associated to the specific drivers, the present invention can also be used in Driver Validation functionality, as described above. Similarly, different embodiments of the invention comprise Itinerary Matching/Identification and Journey Matching/Identification as described herein.

While the present invention has been illustrated by the description of specific embodiments thereof, and while the embodiments have been described in considerable detail, it is not intended to restrict or in any way limit the scope of the appended claims to such detail.

The various features discussed herein may be used alone or in any combination, when possible, as the skilled person will recognise.

Additional advantages and modifications of the present invention will also readily appear to those skilled in the art. The invention in its broader aspects is therefore not limited to the specific details, representative apparatus and methods and illustrative examples shown and described. Accordingly, the skilled person may depart from such details without however departing from the scope of the claims as appended herewith.

1. A method of associating one or more drivers to a vehicle, the method comprising:
providing a reference itinerary between a first destination O and a second destination A, and N reference locations L1, L2, . . . , LN situated on said reference itinerary;
for each of different journeys performed by any one of the drivers by driving the vehicle on the reference itinerary,
capturing at least one signal capable of representing the driving of said driver in connection with each of said N reference locations L1, L2, . . . , LN; and
comparatively evaluating the captured signals.

2. A method according to claim 1, wherein comparatively evaluating the captured signals comprises:
processing the captured signals to obtain N post-processing results for each signal, said N results being associated, respectively, with said reference locations along the reference itinerary; and
evaluating the post-processing results.

3. A method according to claim 2, wherein the method further comprises:
transmitting the captured signals and/or the post-processing results to a remote server or memory;
wherein processing the captured signals and/or evaluating the post-processing results are carried out remotely;
wherein transmitting the captured signals and/or post-processing results to the remote server or memory are optionally carried out by a telematics system associated with the vehicle.

4. A method according to claim 2, wherein evaluating said post-processing results comprises:
clustering the post-processing results around said N locations for the different journeys; and,
comparing said clustered post-processing results;
wherein the method optionally comprises capturing said at least one signal for a large plurality of the journeys.

5. (canceled)

6. (canceled)

7. A method according to claim 1, wherein the first destination O represents a home location for the vehicle and wherein the method further comprises:
setting the home location;
wherein setting the home location optionally comprises determining a frequency of vehicle ignition and/or vehicle stop events associated with the home location;
wherein setting the home location and/or determining said frequency of vehicle ignition and/or vehicle stop events is optionally carried out by a telematics system associated with the vehicle.

8. A method according to claim 1, comprising:
providing two or more reference itineraries for the vehicle, and corresponding sets of reference locations on said reference itineraries, each reference itinerary being between a first destination O and a respective second destination A, B, C;
for each of different journeys performed by any one of the one or more drivers by driving the vehicle on any one of the reference itineraries,
capturing at least one signal representative of the driving of said driver in conjunction with each of the reference locations on said reference itinerary.

9. A method according to claim 1, wherein capturing at least one signal representative of the driving of said driver in connection with said reference locations and/or comparatively evaluating the captured signals are performed when the driver drives the vehicle only out of said first destination O, or only into said first destination O.

10. A method according to claim 1, wherein providing said reference itinerary or itineraries and/or reference locations on one or more reference itineraries, and/or capturing at least one signal representative of the driving of said driver in connection with said reference locations are carried out by a telematics system associated with the vehicle.

11. A method according to claim 10, wherein the telematics system optionally comprises a GPS receiver programmed to receive a GPS signal representing a position or speed of the vehicle; wherein the GPS receiver is optionally provided within a GPS enabled device such as within a GPS navigator and/or within a GPS enabled smartphone or GPS enabled portable computer.

12. A method according to claim 10, wherein said telematics system comprises one or more sensors for sensing the at least one signal representative of the driving of said driver; wherein said telematics system optionally comprises a smartphone or portable computer programmed to capture said at least one signal representative of the driving of said driver; wherein said telematics system optionally is a GPS enabled smartphone or portable computer comprising the one or more sensors; wherein said one or more sensors comprise any one or more of an accelerometer, a gyroscope and a magnetometer.

13. A method according to claim 10, wherein capturing the at least one signal representative of the driving of said driver is triggered by corresponding triggers issued by the telematics system in correspondence to, or before the vehicle has reached the, reference locations; wherein said triggers are optionally issued by the GPS enabled device.

14. A method according to any one of claims 10, wherein capturing the at least one signal representative of the driving of said driver comprises capturing said at least one signal when the vehicle is at said reference locations.

15. A method according to any one of claims 10, wherein capturing said at least one signal is carried out over discrete data sequence captures performed before, while or after the vehicle is driven at any one or more of the reference locations.

16. A method according to claim 15, wherein the discrete data sequences are captured within predetermined finite time intervals or distances travelled by the vehicle in connection with any of the reference locations; wherein said time intervals or distances are optionally fixed, or are optionally dependent on the reference locations; wherein said time intervals and/or distances are optionally determined by the telematics system, or are provided to the telematics system; wherein at least some of said reference locations are optionally equally spaced from one another, optionally by about 100 meters.

17. A method according to claim 1, wherein capturing the at least one signal is carried out uninterruptedly along the journey.

18. A method according to claim 1, wherein said at least one signal representative of the driving of said driver is one or more of: a vehicle acceleration; a vehicle deceleration; a vehicle speed; a vehicle angular velocity; a vehicle position; and/or a parameter directly or indirectly derived therefrom.

19. (canceled)

20. (canceled)

21. A method according to claim 1, wherein comparatively evaluating the captured signals comprises aggregating the captured signals around said N reference locations.

22. (canceled)

23. (canceled)

24. (canceled)

25. (canceled)

26. A telematics system adapted to carry out the method according to claim 1.

27. A telematics system according to claim 26, the system comprising:
a GPS receiver for receiving a GPS signal representative of the position or speed of the vehicle;
a sensing device comprising one or more sensors for acquiring the at least one signal representative of the driving of driver in connection with any of the reference locations; and,
a communication device capable of communicating signals to a remote repository;
wherein the GPS receiver, sensing device and communication device are each or all integrated into a smartphone or portable computer.

28. Programming code, published, stored or installed onto a physical medium, said programming code containing instructions for setting up a telematics system as claimed in claim 26.

29. (canceled)

30. (canceled)
